(19) United States
(12) Patent Application Publication
(10) Pub. No.: US 2014/0314303 A1
(43) Pub. Date: Oct. 23, 2014

(54) TESTING SYSTEM FOR LIGHT-EMITTING DIODE AND METHOD FOR TESTING LIGHT-EMITTING DIODE USING THE SAME

(71) Applicant: ADVANCED OPTOELECTRONIC TECHNOLOGY, INC., Hsinchu Hsien (TW)

(72) Inventor: CHE-HSANG HUANG, Hsinchu (TW)

(73) Assignee: ADVANCED OPTOELECTRONIC TECHNOLOGY, INC., Hsinchu Hsien (TW)

(21) Appl. No.: 14/077,221

(22) Filed: Nov. 12, 2013

(30) Foreign Application Priority Data
Apr. 22, 2013 (CN) 2013101399226

(51) Int. Cl. G06T 7/00

(52) U.S. Cl. CPC G06T 7/001
USPC 382/145

(57) ABSTRACT

A testing system for light-emitting diodes (LEDs) includes a data storage module, a data obtaining module and a comparison module. The data storage module stores pre-setting CIE spectrum data of a standard LED. The data obtaining module includes an image sensing module including a charge-coupled device sensor for capturing an image of a light distribution of an LED to be tested, a data reading module and a computing module. The data obtaining module obtains optical data from the captured and recorded image. The computing module computes to get CIE spectrum data based on the optical date. The comparsion module compares the pre-setting CIE spectrum data with the CIE spectrum data computed by the computing module to determine whether the tested LED passes the test. This disclosure also relates to a method for testing LEDs using the testing system.

### BACKGROUND

1. Technical Field

The disclosure generally relates to testing systems, particularly, to a testing system for testing optical characteristics of light emitting diodes and a method for testing the light emitting diodes using the testing system.

2. Description of Related Art

A conventional testing system for light emitting diodes includes an integrating sphere, and optical characteristics of the light emitting diodes are detected based on illumination of the light emitting diodes on the integrating sphere of the testing system.

However, because the integrating sphere which is a key part of the conventional testing system for light emitting diodes is expensive, a cost of testing the light emitting diodes by using the testing system having an integrating sphere is high.

What is needed, therefore, is a testing system for light emitting diodes and a method for testing the light emitting diodes using the testing system which can eliminate the problem of the conventional art.

### BRIEF DESCRIPTION OF THE DRAWINGS

FIG. 1 is a block diagram of a testing system for light emitting diodes in accordance with an exemplary embodiment of the present disclosure.

FIG. 2 is a block diagram of a data obtaining module of the testing system of FIG. 1.

FIG. 3 is a flowchart showing steps of a method for testing the optical characteristics of light emitting diodes using the testing system of FIG. 1.

### DETAILED DESCRIPTION

An testing system for light emitting diodes in accordance with an exemplary embodiment of the present disclosure will now be described in detail below and with reference to the drawings.

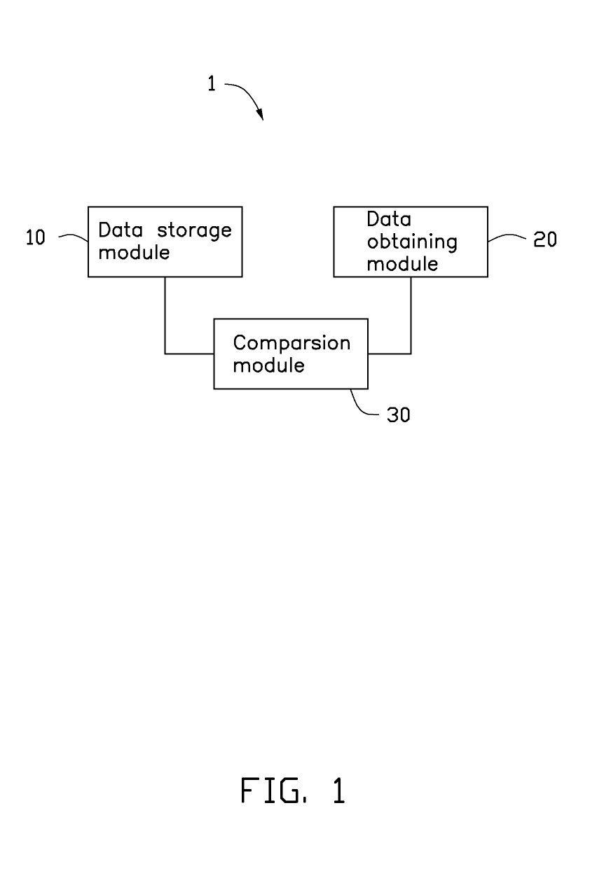

Referring to FIG. 1, a testing system 1 for testing optical characteristics of light emitting diodes includes a data storage module 10, a data obtaining module 20 and a comparison module 30 used to compare the data in the data storage module 10 with the data obtained by the data obtaining module 20.

The data storage module 10 stores data of a CIE (International Commission on Illumination) spectrum of a preselected standard light emitting diode, which meet prescribed requirements. The data obtaining module 20 is used to obtain spectrum data of a light emitting diode to be tested. The comparison module 30 is used to compare the spectrum data in the data storage module 10 with the spectrum data obtained by the data obtaining module 20 to determine whether the tested light emitting diode can meet the prescribed requirements or not.

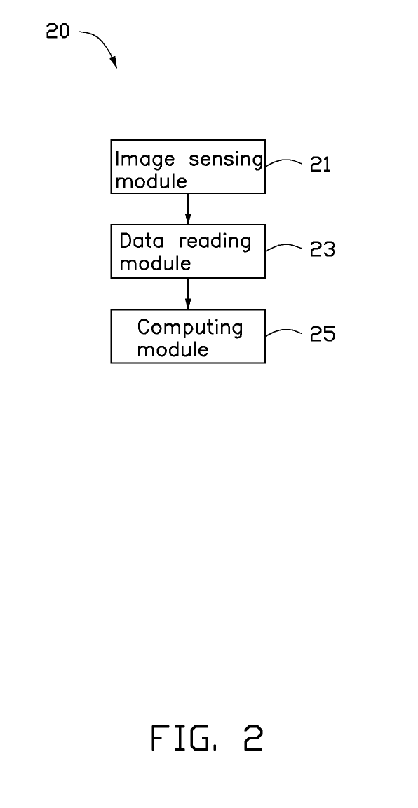

Referring to FIG. 2, the data obtaining module 20 includes an image sensing module 21, a data reading module 23 and a computing module 25.

The image sensing module 21 can capture the image of light emitted from a light emitting diode to be tested, and can store the captured image in a storage device, such as a writable/readable optical disk (not illustrated) or a solid-state memory module (not illustrated). The image sensing module 21, for example, a digital image capturing device such as a digital camera, includes a charge-coupled device (CCD) sensor. In this embodiment, the image sensing module 21 is used to capture an image of the light distribution of the light emitting diode to be tested.

The data reading module 23 reads and obtains the optical data in the image captured by the image sensing module 21. In this embodiment, the data reading module 23 can read and obtain a series of coordinates (R, G, B) corresponding to red light (R), green light (G) and blue light (B) of different intensities at different illumination angles, respectively.

The computing module 25 computes the optical data to obtain a spectrum data of the light emitting diode to be tested. In this embodiment, the computing module 25 computes to obtain a CIE spectrum data of the light emitting diode based on the series of the coordinates (R, G, B) obtained by the data reading module 23.

The comparison module 30 compares the CIE spectrum data of the standard light emitting diode in the data storage module 10 with the CIE spectrum data computed by the computing module 25 to determine whether the tested light emitting diode meets the prescribed requirements or not.

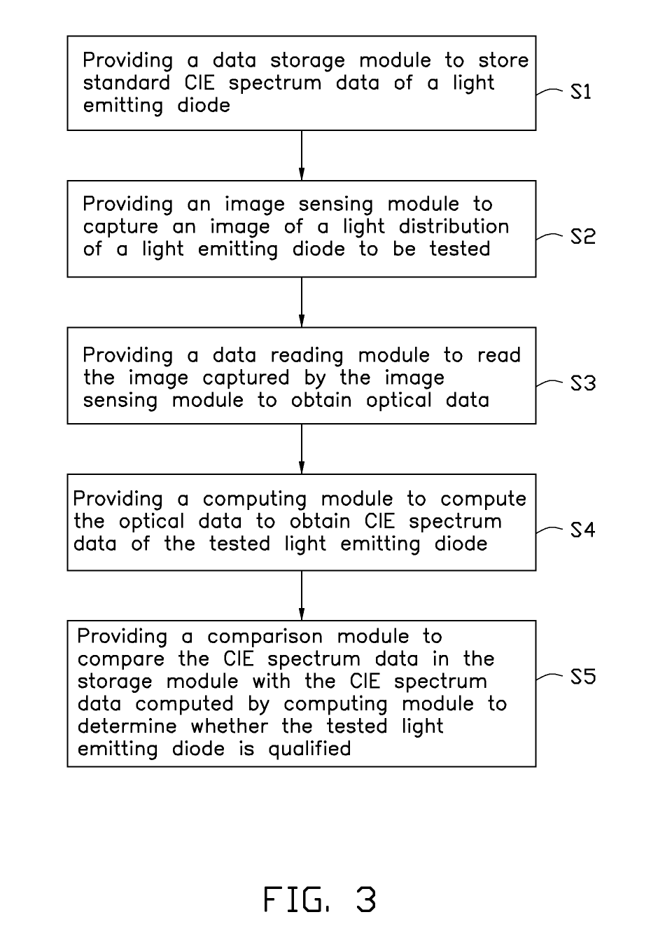

Referring to FIG. 3, a method for testing optical characteristics of light emitting diodes using the testing system 1 is provided, and the method includes following steps:

S1: providing the data storage module 10 to store CIE spectrum data of a standard light emitting diode;

S2: providing the image sensing module 21 to capture an image of a light distribution of a light emitting diode to be tested;

S3: providing the data reading module 23 to read and obtain the optical data in the image captured by the image sensing module 21;

S4: providing a computing module 25 to compute the optical data in the image to obtain CIE spectrum data of the tested light emitting diode;

S5: providing the comparison module 30 to compare the CIE spectrum data in the storage module 10 with the CIE spectrum data computed by the computing module 25 to determine whether the tested light emitting diode meets the prescribed requirements or not.

In this embodiment, the comparing module 30 transfers the CIE spectrum data of the standard light emitting diode in the storage module 10 and the CIE spectrum data computed by the computing module 25 to a same coordinate system, and then compares the values of the coordinates of the CIE spectrum data of the standard light emitting diode with the corresponding values of the coordinates of the CIE spectrum data of the tested light emitting diode to determine a deviation therebetween. If the deviation is within an acceptable range, the tested light emitting diode meets the prescribed requirements and passes the test. The acceptable range is adjustable according to the practical requirement.

According to the testing system for testing light emitting diodes and a method for testing light emitting diodes using the testing system, the optical characteristics of the light emitting diodes is tested by the data storage module 10, the data obtaining module 20 which can include a digital camera and the comparison module 30 instead of an expensive integrating sphere, whereby the cost of testing the optical characteristics of a light emitting diode is decreased.

It is to be understood that the above-described embodiments are intended to illustrate rather than limit the disclosure. Variations may be made to the embodiments without departing from the spirit of the disclosure as claimed. The above-described embodiments illustrate the scope of the disclosure but do not restrict the scope of the disclosure.

What is claimed is:

1. A testing system for light emitting diodes, comprising:
a data storage module storing pre-setting CIE spectrum data of a standard light emitting diode whose illumination meets prescribed requirements;
a data obtaining module for obtaining CIE spectrum data of a tested light emitting diode; and
a comparison module comparing the pre-setting CIE spectrum data with the CIE spectrum data obtained by the data obtaining module to determine whether the tested light emitting diode meets the prescribed requirements.

2. The testing system of claim 1, wherein the data obtaining module comprises an image sensing module, a data reading module and a computing module, the image sensing module captures an image of a light distribution of the tested light emitting diode, the data reading module reads the image to obtain an optical data, and the computing module computes to obtain the CIE spectrum data of the tested light emitting diode based on the optical data.

3. The testing system of claim 2, wherein the image sensing module comprises a digital image capturing device.

4. The testing system of claim 3, wherein the digital image capturing device is a digital camera.

5. The testing system of claim 4, wherein the digital camera includes a charge-coupled device sensor.

6. The testing system of claim 2 wherein the image sensing module comprises a charge-coupled device sensor.

7. The testing system of claim 2, wherein the optical data comprises data of a series of coordinates (R, G, B) corresponding to red light (R), green light (G) and blue light (B) of different intensities at different illumination angels of light of a light emitting diode to be tested.

8. A method for testing light emitting diodes comprises following steps:
S1: providing a data storage module to store pre-setting CIE spectrum data of a standard light emitting diode;
S2: providing an image sensing module to capture an image of a light distribution of a light emitting diode to be tested;
S3: providing a data reading module to read the image captured by the image sensing module to obtain optical data;
S4: providing a computing module to compute the optical data to obtain CIE spectrum data of the tested light emitting diode; and
S5: providing a comparison module to compare the pre-setting CIE spectrum data in the storage module with the CIE spectrum data computed by the computing module to determine whether the tested light emitting diode meet prescribed requirements.

9. The method of claim 8, wherein the image sensing module comprises a digital camera.

10. The method of claim 9, wherein the digital camera includes a charge-coupled device sensor.

11. The method of claim 8, wherein the optical data comprises data of a series of coordinates (R, G, B) corresponding to the red light, green light and the blue light of different intensities at different illumination angles of light emitted from the tested light emitting diode, respectively.

12. The method of claim 8, further comprising transferring the pre-setting CIE spectrum data and the CIE spectrum data of the tested light emitting diode to a same coordinate system in the step S5.

13. The method of claim 8, wherein a deviation is obtained when comparing the pre-setting CIE spectrum data with the CIE spectrum data of the tested light emitting diode in the step S5.
